(19) United States
(12) Patent Application Publication
(10) Pub. No.: US 2012/0076266 A1
(43) Pub. Date: Mar. 29, 2012

(54) PORTABLE X-RAY DETECTOR AND X-RAY RADIOGRAPHY METHOD USING THE SAME

(76) Inventors: Jong Chul KIM, Hwaseong-si (KR); Sung Jin Jang, Hwaseong-si (KR)

(21) Appl. No.: 13/233,313

(22) Filed: Sep. 15, 2011

(30) Foreign Application Priority Data
Sep. 15, 2010 (KR) 10-2010-0090742

(51) Int. Cl. G01N 23/04; G01T 1/00

(52) U.S. Cl. 378/62; 250/336.1

(57) ABSTRACT

A portable X-ray detector includes: a detection panel having an incident surface defined on a front surface thereof facing a generator and configured to generate an electrical signal for each position which is proportional to an incident amount of X-rays generated from the generator; a backing housing detachably fixed to a rear surface of the detection panel and having a sealed mounting space defined therein; and a communication module mounted in the mounting space and configured to wirelessly transmit the electrical signal generated from the detection panel.

### BACKGROUND OF THE INVENTION

The present invention relates to an x-ray detector and an X-ray radiography method using the same, and more particularly, to a portable X-ray detector which may be separated from an X-ray system including a generator, a user terminal, and a power supply and wirelessly used, and an X-ray radiography method using the same.

X-rays refer to short-wavelength electromagnetic waves having a wavelength range of 0.01 nm˜10 nm and a frequency range of 30×10¹⁵ Hz˜30×10¹⁸ Hz. X-ray radiography refers to radiography which displays the inside of a target using a high penetration force of X-rays.

As well known, X-rays accompany attenuation such as photoelectric effect or Compton scattering, depending on the material, density, and thickness of an object, while penetrating the object. Therefore, X-ray radiography displays a projected image for the inside of the object at a plane gray scale, based on an attenuation amount of X-rays which are accumulated while the X-rays penetrate the object. For this operation, a separate X-ray system is used.

A general X-ray system necessarily includes a generator, a detector, and a power supply unit. The generator serves to generate X-rays to irradiate onto a target. The detector is disposed to face the generator, with the target interposed therebetween, and serves to detect an attenuation amount of X-rays which are accumulated while passing through the target. The power supply unit serves to supply power to components requiring power, such as the generator and so on.

The generator generates X-rays by colliding electrons having high kinetic energy with a metallic target. At this time, a typical generator includes an optical system such as a collimator to control the irradiation direction or irradiation area of X-rays.

The detector is divided into an analog type and a digital type. The analog type detector combines an X-ray intensifying screen and a silver salt film to implement a latent image on the silver salt film through the light of the X-ray intensifying screen, and then develops the silver salt film to thereby obtain a radiography result. Therefore, the analog type detector requires an additional equipment or process for developing the silver salt.

The analog type detector requires large time and cost consumption for the development process and so on, and accompanies difficulties in storing films. Accordingly, the use of the analog-type detector has gradually decreased.

In the digital type detector, two-dimensional sensors are implemented as detection media which respond to X-rays, and an electrical signal for each sensor which is proportional to an incident amount of X-rays is obtained through an X-ray detector which is a matrix arrangement of the sensors, and then processed into digital image data. Therefore, the digital-type detector requires a signal processor for obtaining image data from an electrical signal of the X-ray detector and an image display device such as a monitor for displaying image data to a user.

Since the digital type detector may obtain a radiography result almost in real time and the digital data may be easily stored and processed, much attention has been recently paid to the digital type detector.

For reference, the digital type X-ray detector may be divided into a direct conversion type and an indirect conversion type. The direct conversion type X-ray detector directly obtains an electrical signal from X-rays using a photoelectric material. The indirect conversion type X-ray detector indirectly obtains an electrical signal from visible rays using a scintillator such as an intermediate medium. The indirect conversion type detector may be divided into a charge-coupled device (CCD) type, a complementary metal-oxide semiconductor (CMOS) type, and an a-Si type. The CCD-type X-ray detector uses a CCD depending on a device for generating an electrical signal. The CMOS-type X-ray detector uses a CMOS device formed of crystalline silicon. The a-Si-type X-ray detector uses a thin-film transistor (TFT) substrate formed of amorphous silicon.

FIG. 1 is a schematic view of a conventional X-ray system using a digital type detector. Hereinafter, for convenience of description, the digital type detector is referred to as an X-ray detector, and the entire system is referred to as an X-ray system. In the entire specification, they indicate the same meanings.

Referring to FIG. 1, the conventional X-ray system includes a generator 2, an X-ray detector 4, a signal processor 8, a monitor 10, and a power supply unit 12.

The generator 2 generates X-rays to irradiate onto a target, and the X-ray detector 4 is disposed to face the generator 2, with the target interposed therebetween, and includes a detection panel configured to generate an electrical signal for each position based on an incident amount of X-rays passing through the target. At this time, the detection panel may be fixed to a bucky or the like, if necessary, and the generator 2 and the bucky are connected to a mechanism.

The signal processor 8 amplifies an electrical signal transmitted from the X-ray detector 4, converts the amplified signal into digital data, generates gray-scale image data based on the digital data, and displays the generated image data to a user through the monitor 10. At this time, a typical user terminal 6 such as a personal computer may be utilized as the signal processor 8 and the monitor 10, and is connected to the generator 2 and the X-ray detector 4 through a wire.

Furthermore, the power supply unit 12 is connected to the generator 2 and the X-ray detector 4 through a wire, and supplies power.

However, the above-described conventional X-ray system exhibits several disadvantages. A representative example of the disadvantages is that, since the generator 2, the X-ray detector 4, the user terminal 6, and the power supply unit 12 are connected through a wire or mechanism, the portability and utilization of the X-ray system decreases, and thus the X-ray system has temporal and spatial limits.

Specifically, X-ray radiography may be performed in a variety of places such as indoor and outdoor places, depending on objectives or the types of targets, and the distance between the generator 2 and the X-ray detector 4 may be frequently adjusted. Such a case frequently occurs when an animal such as a horse is set to a target of the X-ray radiography.

However, the conventional X-ray system has an integrated structure in which the generator 2, the X-ray detector 4, the user terminal 6, and the power supply unit 12 are connected through a wire or mechanism. Therefore, since a complex process of disassembling and assembling the X-ray system is required to move and install the X-ray system, the portability and utilization of the X-ray system decreases, and the X-ray system has temporal and spatial limits. Furthermore, the X-ray system contains a problem in that the X-ray system may malfunction or may be damaged due to a wrong wire connection during the disassembling and assembling process for changing an installation place.

### SUMMARY OF THE INVENTION

An embodiment of the present invention is directed to a substantial and effective method capable of increasing the portability and utilization of an X-ray system and reducing temporal and spatial limits.

Another embodiment of the present invention is directed to a portable X-ray detector which enables X-ray radiography even in a state in which it is separated from an X-ray system including a generator, a user terminal, and a power supply unit. The portable X-ray detector may wirelessly communicate with the user terminal, may receive power from a battery mounted therein, and may be universally applied to an existing X-ray detector.

Another embodiment of the present invention is directed to an X-ray radiography method using the X-ray detector, which is capable of improving the portability and reliability of the X-ray system.

In accordance with an embodiment of the present invention, a portable X-ray detector includes: a detection panel having an incident surface defined on a front surface thereof facing a generator and configured to generate an electrical signal for each position which is proportional to an incident amount of X-rays generated from the generator; a backing housing detachably fixed to a rear surface of the detection panel and having a sealed mounting space defined therein; and a communication module mounted in the mounting space and configured to wirelessly transmit the electrical signal generated from the detection panel.

In accordance with another embodiment of the present invention, there is provided an X-ray radiography method using a portable X-ray detector which includes a user terminal configured to perform a wireless communication and generate a synchronization signal according to a user's manipulation, a generator connected to the user terminal through a wire and configured to generate X-rays according to a radiography signal transmitted from the user terminal, a battery, and a communication module for wireless communication with the user terminal. The X-ray radiography method includes: generating the synchronization signal from the user terminal, and wireless transmitting the synchronization signal to the X-ray detector; synchronizing the X-ray detector, generating a synchronization completion signal from the communication module, and wirelessly transmitting the synchronization completion signal to the user terminal; transmitting the radiography signal to the generator from the user terminal; and generating X-rays from the generator, generating an electrical signal for each position, which is proportional to an incident amount of the X-rays, from the X-ray detector, and wirelessly transmitting the electrical signal to the user terminal.

### BRIEF DESCRIPTION OF THE DRAWINGS

FIG. 1 is a schematic view of a conventional X-ray system.

FIGS. 2 and 3 are perspective views of a portable X-ray detector according to an embodiment of the present invention, seen from different directions.

FIGS. 4 and 5 are exploded perspective views of the portable X-ray detector according to the embodiment of the present invention, seen from different directions.

FIG. 6 is a cross-sectional view taken along a line VI-VI of FIG. 4.

FIG. 7 is a schematic view of an X-ray system using the X-ray detector according to the embodiment of the present invention.

FIG. 8 is a flow chart showing an X-ray radiography method according to the embodiment of the present invention.

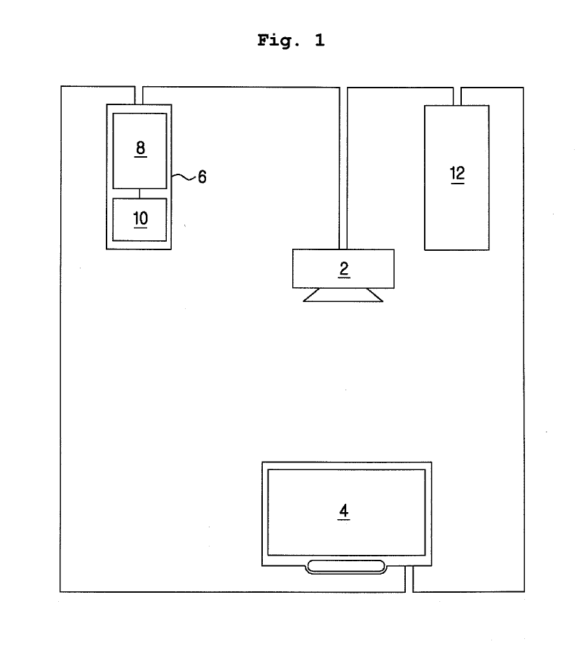

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

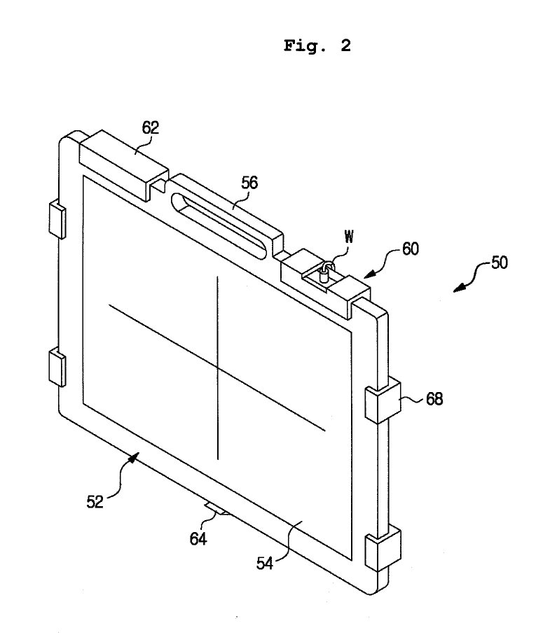

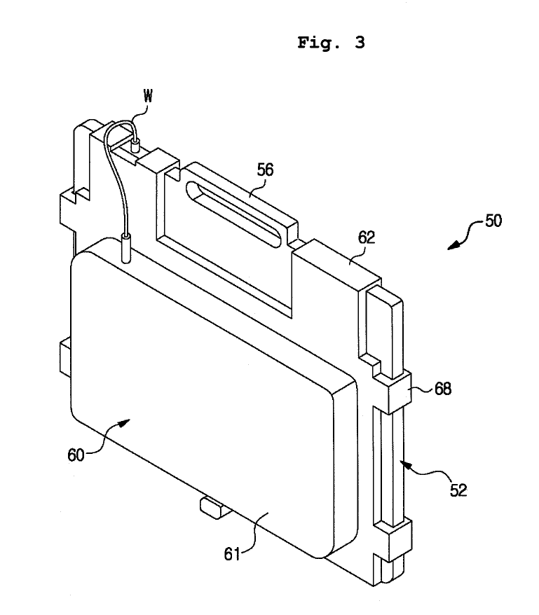

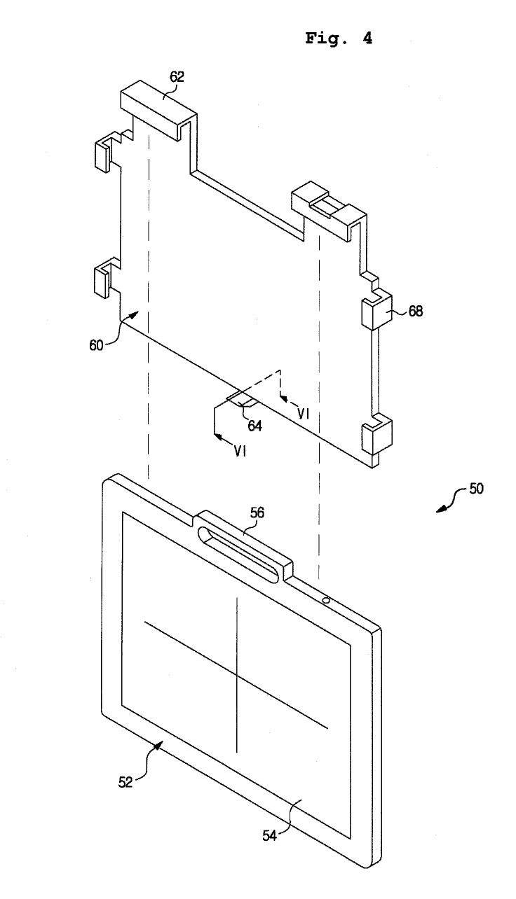

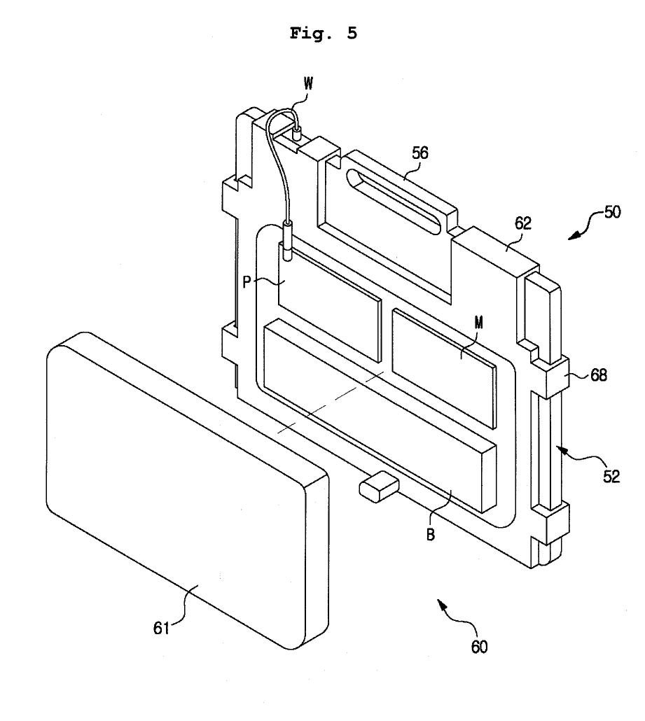

FIGS. 2 and 3 are perspective views of an X-ray detector 50 according to an embodiment of the present invention, seen from different directions. FIGS. 4 and 5 are exploded perspective views of the X-ray detector 50 according to the embodiment of the present invention, seen from different directions.

Referring to FIGS. 2 and 3, the X-ray detector 50 according to the embodiment of the present invention includes a detection panel 52 and a backing housing 60 which is detachably fixed to the rear surface of the detection panel 52. For reference, FIG. 2 is a front perspective view illustrating the front surface of the X-ray detector 50 according to the embodiment of the present invention. FIG. 3 is a rear perspective view illustrating the rear surface in the opposite side thereof. FIG. 4 is an exploded perspective view of the detection panel 52 and the backing housing 60. FIG. 5 is an exploded perspective view of the backing housing 60.

The respective components will be described as follows.

The detection panel 52 includes a matrix arrangement of 2D sensors responding to X-rays, and each of the sensors generates an electrical signal proportional to an incident amount of X-rays.

For this operation, an incident surface 54 on which X-rays are incident is defined on the front surface of the detection panel 52, and the plurality of sensors are arranged in a matrix shape inside the detection panel 52. In this case, a direct conversion type detection panel using a photoelectric material and an indirect conversion type detection panel using a scintillator may be used as the detection panel 52, as long as they are digital type detection panels.

However, considering that the X-ray detector 50 according to the embodiment of the present invention is separated from an X-ray system including a generator, a user terminal, and a power supply unit, which will be described below, and then used as a wireless portable X-ray detector, the detection panel 52 may be formed in such a manner as to have a large area and a small thickness. For example, an a-Si type X-ray detector called a flat panel detector (FPD) and based on a TFT substrate formed of amorphous silicon is used.

Desirably, a handle 56 is provided in the center of the top of the detection panel 52.

The backing housing 60 is detachably fixed to the rear surface of the detection panel 52, and includes a communication module M and a battery B which are mounted therein. The communication module M serves to wirelessly communicate with the outside, and the battery B serves to provide power to the detection panel 52 and the communication module M.

For this structure, the backing housing 60 includes one or more hook members 62 which are provided at the top thereof and hung on the edges of the top of the detection panel 52, one or more support members 64 which are provided at the bottom of the backing housing 60 and support the edges of the bottom of the detection panel 52, and one or more guide members 68 which are provided on side surfaces of the backing housing 60 and guide side edges of the detection panel 52.

Desirably, two or more hook members 62 of the backing housing 60 may be disposed with the handle 56 of the detection panel 52 interposed therebetween. For example, as illustrated in the drawings, a pair of hook members may be disposed in the left and right sides of the handle 56 and formed in such a hook shape that is hung across the top of the detection panel to the edges of the front surface.

Therefore, a user closely attaches the top of the detection panel 52 and the bottom of the backing housing 60 and then pushes up the detection panel 52 such that the hook members 62 of the backing housing 60 are hung on the detection panel 52 to fix the detection panel 52. After fixing the detection panel 52, the user may carry the entire X-ray detector by holding only the handle 56 of the detection panel 52.

Desirably, the support member 64 supports the center of the bottom of the detection panel 52. For example, as illustrated in the drawings, the bottom surface of the support member 64 facing the detection panel 52 may be formed in such a shape that is tapered upward toward the end thereof, and is advanced and retreated in a direction from the backing housing 60 to the detection panel 52 by an elastic unit such as a spring.

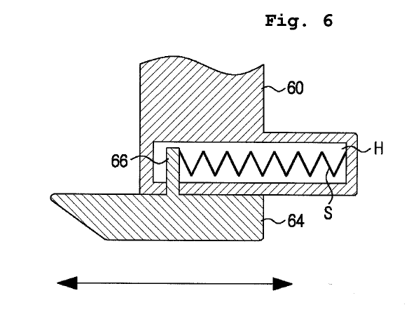

FIG. 6 is a cross-sectional view taken along a line VI-VI of FIG. 4, illustrating a part of the bottom of the backing housing 60 and the support member 64. The following descriptions are also based on FIGS. 2 to 5.

As illustrated in FIG. 6, a long insertion hole H is formed at the bottom of the backing housing 60 so as to face the detection panel 52 from the backing housing 60, and a support protrusion 66 is formed on the top of the support member 64 and inserted so as to move along the longitudinal direction of the long insertion hole H. Furthermore, an elastic unit S such as a coil spring is mounted in the long insertion hole H and exhibits such an elasticity as to push the support member 64 toward the detection panel 52.

Therefore, while the user closely attaches the top of the detection panel 52 and the bottom of the backing housing 60 and then pushes up the detection panel 52 to fix the detection panel 52 and the backing housing 60, the support member 64 maintains a state in which it is pressed toward the backing housing 60. Therefore, the support member 64 does not interfere with the movement of the detection panel 52. However, when the hook members 62 of the backing housing 60 are hung on the top of the detection panel 52, the support member 64 is moved toward the detection panel 52 and stably supports the bottom of the detection panel 52.

Furthermore, one or more guide members 68 for guiding the side surfaces of the detection panel 52 are provided on the side surfaces of the backing housing 60. Desirably, two pairs of guide members 68 to guide the left and right surfaces of the detection panel 52, respectively, may be formed in such a hook shape that is hung across the side surfaces of the detection panel 52 to the edge of the front surface.

Therefore, the guide members 68 stably guide the left and right surfaces of the X-ray detector 52 after the detection panel 52 and the backing housing 60 are fixed, thereby preventing the side-to-side movement of the X-ray detection panel 52.

Meanwhile, a sealed mounting space is defined inside the backing housing 60. For this structure, a separate rear cover 61 is coupled to the rear surface of the backing housing 60. Furthermore, the battery B and the communication module M for wirelessly communicating with the outside are mounted in the mounting space.

At this time, the communication module M may include a near-field communication module such as IrDA (Infrared Data Association) Wi-Fi (wireless LAN), Bluetooth, ZigBee, or UWB (Ultra Wideband), which supports near field communication, and the battery B may include a rechargeable secondary battery. For reference, although not illustrated, a charging terminal of the battery B is exposed to one side of the rear cover 61, and the communication module M may include an antenna exposed to the outside through the rear cover 61.

Desirably, a separate control circuit P for controlling the communication module M and the battery B is mounted in the mounting space, and the battery B and the communication module M are connected to the detection panel 52 through a cable W.

The above-described X-ray detector 50 according to the embodiment of the present invention may wirelessly communicate with the outside and receive power from the battery mounted therein. Therefore, the X-ray detector 50 may be separated from an X-ray system including a generator, a user terminal, and a power supply unit, and used as a wireless portable X-ray detector.

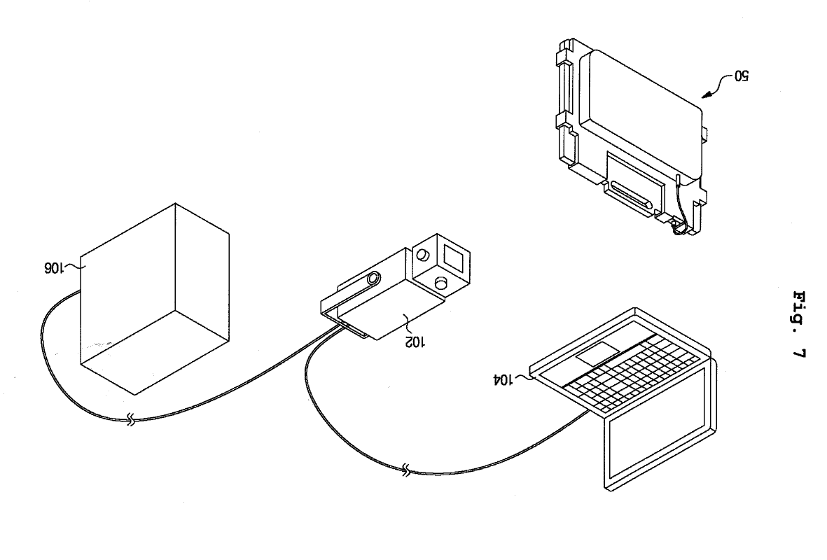

FIG. 7 is a schematic view of an X-ray system using the X-ray detector 50 according to the embodiment of the present invention. The following descriptions are also based on FIGS. 2 to 5, and reference numerals of the detailed components of the X-ray detector are omitted, for convenience of explanation.

As illustrated in the drawings, the X-ray system according to the embodiment of the present invention includes a generator 102, a user terminal 104, a power supply unit 106, and an X-ray detector 50.

The respective components will be described as follows.

The generator 102 generates X-rays to irradiate onto a target. Desirably, the generator 102 may include an optical system such as a collimator, which controls the irradiation area or irradiation direction of the X-rays.

The X-ray detector 50 is disposed to face the generator 102 with the target interposed therebetween, generates an electrical signal for each position according to an incident amount of X-rays passing through the target, and wirelessly transmits the electrical signal to the user terminal 104 through the communication module M. At this time, the entire power required by the X-ray detector 50 is supplied from the battery B mounted in the X-ray detector 50, and the communication module M converts the electrical signal into a digital packet and transmits the digital packet.

The user terminal 104 wirelessly communicates with the X-ray detector 50, converts and processes the electrical signal transmitted from the X-ray detector 50 into digital image data, and displays the digital image data to a user.

For this operation, a computer including a communication module for wireless communication, a signal processor for converting and processing an electrical signal into image data, and a monitor for displaying image data may be used as the user terminal 104. At this time, the user terminal 104 may include a separate controller which is configured to control the synchronization between the generator 102 and the X-ray detector 50 and the X-ray generation of the generator 102, and is connected to the generator 102 through a wire.

The power supply unit 106 is connected to the generator 102 through a wire, and supplies a high voltage for the generation of X-rays.

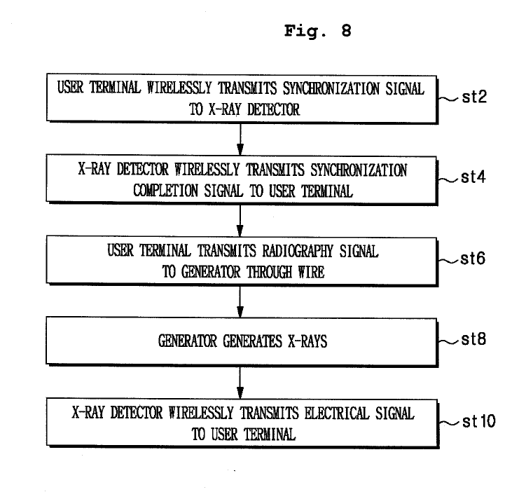

FIG. 8 is a flow chart showing an X-ray radiography method using the X-ray detector 50 according to the embodiment of the present invention. The following descriptions will be also based on FIG. 7.

First, a user uses the user terminal 104 to generate a synchronization signal for synchronization of the X-ray detector 50, and the user terminal 104 wirelessly transmits the generated synchronization signal to the X-ray detector 50, at step ST2.

At this time, the user terminal 104 may provide a user interface for the generation of the synchronization signal. The corresponding function may be allocated to a separate switch connected to the user terminal 104 through a wire.

Then, when the synchronization signal of the user terminal 104 is received by the communication module M of the X-ray detector 50, the detection panel 52 is synchronized by the power of the battery B. When the synchronization is completed, the communication module M wirelessly transmits a synchronization completion signal to the user terminal 104, at step ST4.

At this time, the synchronization of the X-ray detector 50 and the generation of the synchronization completion signal may be performed in the control circuit P mounted in the X-ray detector 50.

When the synchronization completion signal of the X-ray detector 50 is received by the user terminal 104, the user terminal 104 generates a radiography signal for X-ray generation of the generator 102, and transmits the generated radiography signal to the generator 102, at step ST6.

When the radiography signal is received by the generator 102, the generator 102 generates X-rays, and the X-ray detector 50 generates an electrical signal proportional to an incident amount of X-rays passing through a target, and wirelessly transmits the generated electrical signal to the user terminal 102 through the communication module M, at steps ST8 and ST10.

As a result, the user terminal 104 converts and processes the electrical signal received from the X-ray detector 50 into image data, and then displays the image data through the monitor. Accordingly, the X-ray detector 50 enables the X-ray radiography in wireless and portable manners, even in a state in which the X-ray detector 50 is separated from the X-ray system including the generator 102, the user terminal 104, and the power supply unit 106.

According to the embodiment of the present invention, the X-ray detector enables X-ray radiography even in a state in which it is separated from an X-ray system including a generator, a user terminal, and a power supply unit. Therefore, it is possible to increase the portability and utilization of the X-ray system and significantly reduce temporal and spatial limits.

Furthermore, the X-ray detector may be universally applied to an existing detection panel and stably coupled to and separated from the detection panel. Therefore, the application range of the X-ray detector may be widened, and the reliability of X-ray radiography may be significantly improved.

Furthermore, the X-ray radiography method exhibits a characteristic suitable for a wireless and portable X-ray detector, thereby increasing the portability and convenience of the X-ray system.

While the present invention has been described with respect to the specific embodiments, it will be apparent to those skilled in the art that various changes and modifications may be made without departing from the spirit and scope of the invention as defined in the following claims.

1. A portable X-ray detector comprising:
a detection panel having an incident surface defined on a front surface thereof facing a generator and configured to generate an electrical signal for each position which is proportional to an incident amount of X-rays generated from the generator;
a backing housing detachably fixed to a rear surface of the detection panel and having a sealed mounting space defined therein; and
a communication module mounted in the mounting space and configured to wirelessly transmit the electrical signal generated from the detection panel.

2. The portable X-ray detector according to claim 1, further comprising a battery mounted in the mounting space and supplying power to the detection panel and the communication module.

3. The portable X-ray detector according to claim 2, wherein the battery comprises a rechargeable secondary battery, and the battery and the communication module are connected to the detection panel through a cable extended from one side of the backing housing.

4. The portable X-ray detector according to claim 1, further comprising:
one or more hook members provided at the top of the backing housing and hung on edges of the top of the detection panel; and
one or more support members provided on the bottom of the backing housing and supporting the bottom of the detection panel.

5. The portable X-ray detector according to claim 4, wherein the support members are advanced or retreated in a direction from the backing housing to the detection panel through an electric unit.

6. The portable X-ray detector according to claim 4, further comprising a handle provided at the top of the detection panel,
wherein two or more hook members are disposed with the handle interposed between.

7. The portable X-ray detector according to claim 4, further comprising one or more guide members provided in at least one side of the backing housing and guiding the side surface of the detection panel.

8. An X-ray radiography method using a portable X-ray detector which includes a user terminal configured to perform a wireless communication and generate a synchronization signal according to a user's manipulation, a generator connected to the user terminal through a wire and configured to generate X-rays according to a radiography signal transmitted from the user terminal, a battery, and a communication module for wireless communication with the user terminal, the X-ray radiography method comprising:
generating the synchronization signal from the user terminal, and wireless transmitting the synchronization signal to the X-ray detector;
synchronizing the X-ray detector, generating a synchronization completion signal from the communication module, and wirelessly transmitting the synchronization completion signal to the user terminal;
transmitting the radiography signal to the generator from the user terminal; and
generating X-rays from the generator, generating an electrical signal for each position, which is proportional to an incident amount of the X-rays, from the X-ray detector, and wirelessly transmitting the electrical signal to the user terminal.

9. The portable X-ray detector according to claim 5, further comprising one or more guide members provided in at least one side of the backing housing and guiding the side surface of the detection panel.

10. The portable X-ray detector according to claim 6, further comprising one or more guide members provided in at least one side of the backing housing and guiding the side surface of the detection panel.
